(19) United States
(12) Patent Application Publication
(10) Pub. No.: US 2004/0017362 A1
(43) Pub. Date: Jan. 29, 2004

(54) Thin face capacitive touch screen

(76) Inventors: Roger C. Mulligan, White Rock (CA); Massoud Badaye, Vancouver (CA)

Correspondence Address: 3M INNOVATIVE PROPERTIES COMPANY, PO BOX 33427, ST. PAUL, MN, 55133-3427, US

(21) Appl. No.: 10/201,400

(22) Filed: Jul. 23, 2002

(51) Int. Cl. G09G 5/00

(52) U.S. Cl. 345/173

(57) ABSTRACT

A capacitive touch sensor is arranged to enable more accurate resolution of a touch location by increasing the signal generated by a touch over background signals. A thin film dielectric protective layer comprising various materials 0.030 inches and less in thickness is disposed on a capacitive touch sensor circuit. The thin film allows the touch to occur in closer proximity to the capacitive touch sensor circuit, thus generating a stronger signal in response to the touch. The thin film can be transparent or opaque, and can be rigid or flexible. The invention also provides a system for returning a signal for use in accurately determining the location of a touch. The system receives an electrical field from a controller, receives a touch, and provides a signal representing the modulation of the electrical field suitable caused by the touch suitable for use in determining the location of the touch.

### FIELD OF THE INVENTION

The present invention relates to capacitive touch screen architecture. More specifically, the invention relates to a thin face capacitive touch screen architecture for use on a surface of a device that is capable of providing a control signal indicative of where the surface was touched.

### BACKGROUND OF THE INVENTION

Touch screens are used in conjunction with a variety of display types, including cathode ray tubes (i.e., CRTs) and liquid crystal display screens (i.e., LCD screens), as a means of inputting information into a computer system. When placed over a display, the touch screen allows a user to select a displayed icon or element by touching the screen in a location that corresponds to the desired icon or element. Touch screens are becoming more prevalent data input interfaces as computers and other electronic devices become ubiquitous. For example, touch screens may now be found in workshops, warehouses, manufacturing facilities, restaurants, on hand-held personal digital assistants, automatic teller machines, casino game-machines, and the like.

Conventionally, Near-Field-Imaging (NFI) touch screens have been employed in relatively harsh environments where the touch screen may be subjected to adverse environmental conditions. Briefly stated, the NFI architecture differs from certain other touch screen architectures in that a plurality of touch-sensitive bars may be employed and addressed such that a contact on the touch screen can be resolved programmatically to a particular bar on the screen. NFI touch screens are particularly well suited to harsher environments because the relatively high degree of sensitivity provided by the NFI architecture enables a protective coating of sufficient thickness that the underlying circuitry remains well protected. Other touch screen architectures are not well-suited so such environments because their relatively lower sensitivity prevents the use of a protective coating of sufficient thickness.

As mentioned, the particular strengths of NFI-type touch screens have made them popular in environments where the touch screen is likely to be exposed to harsher environmental conditions. While the NFI architecture allows a protective substrate of sufficient thickness to withstand the harsh environment, the touch screens typically meet with an abnormally high amount of abuse. Accordingly, these touch screens usually become damaged and require replacement at higher intervals than touch screens in other applications. Until now, this has been an unfortunate consequence of the use of touch screens in abusive environments.

### SUMMARY OF THE INVENTION

The present invention relates to an NFI capacitive touch sensor architecture having a thin dielectric film over the sensor bars. The thin dielectric film protects the sensor bars of the touch sensor from damage due to a touch and makes the touch sensor an enclosed unit. The use of the thin dielectric film may be sufficient for most uses and renders the touch sensor more sensitive than other units having thicker dielectric coverings. In addition, the sensitivity of the NFI capacitive touch sensor architecture allows a second protective layer to be added over the thin dielectric layer without preventing the detection of a touch. In this way, a removable protective layer may be used in conjunction with the touch sensor, enabling the replacement of the removable layer rather than the entire touch sensor.

A capacitive touch sensor of the present invention comprises three layers: a thin dielectric film layer that protects the underlying layers, a capacitive touch sensor circuit layer, and a dielectric backing layer. The dielectric backing layer may be the outer screen of a cathode ray tube or a liquid crystal display. The capacitive touch sensor circuit includes a plurality of sensor bars that are connected to lead lines suitable for carrying a signal representing a touch. The layers comprise a “stack-up” that is either disposed upon a viewing surface as an add-on, or can be formed as a part of the viewing surface during manufacture. Depending on the intended application, the stack-up can be either transparent or opaque, and can be rigid or flexible.

In another aspect of the invention, the thin dielectric film is less than approximately 0.030 inches thick. In other aspects of the invention, the thin dielectric film is further reduced, down to a range between 1,000 and 10,000 Angstroms.

In a further aspect of the invention, the thin dielectric film comprises sheet material, such as polycarbonate or acrylic. The sheet materials can be laminated, bonded, or otherwise disposed upon the capacitive touch sensor layer and the dielectric backing layer.

In yet a further aspect of the invention, the thin dielectric film comprises a flexible film material, such as a polyester.

In another aspect of the invention, the thin dielectric film can be silicon dioxide or other substance suitable for deposition.

In yet another aspect of the invention, the thin dielectric film can be formed by spraying, dip coating, or sputtering.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings which are schematic and not to scale, wherein:

FIG. 1 is a schematic representation of an illustrative environment in which implementations of the invention may be practiced;

FIG. 2 is an exploded view representation of an exemplary capacitive touch sensor having a thin dielectric covering;

FIG. 3 is a cross sectional view of an illustrative touch sensor including a thin dielectric film and a removable protective element; and

FIG. 4 is a schematic representation of an exemplary capacitive touch sensor having a thin dielectric covering, in accordance with the invention.

### DETAILED OF THE PREFERRED EMBODIMENT

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is to be understood that other embodiments may be utilized, and other changes may be made, without departing from the spirit or scope of the present invention. The following detailed description is therefore not to be taken in a limiting sense, and the scope of the present invention is defined only by the appended claims.

Throughout the specification and claims, the following terms take the meanings explicitly associated herein, unless the context clearly dictates otherwise. The meaning of “a”, “an,” and “the” include plural references. The meaning of “in“includes “in” and “on.” The term “connected” means a direct electrical connection between the things that are connected, without any intermediary devices. The term “coupled” means either a direct electrical connection between the things that are connected, or an indirect connection through one or more passive or active intermediary devices. The term “circuit” means one or more passive and/or active components that are arranged to cooperate with one another to provide a desired function. The term “signal” means at least one current signal, voltage signal or data signal. Referring to the drawings, like numbers indicate like parts throughout the views. Additionally, a reference to the singular includes a reference to the plural unless otherwise stated or is inconsistent with the disclosure herein.

Briefly described, the present invention relates to a capacitive touch sensor architecture for use on the surface of a device, for example an LCD or CRT display, or on a touch pad. More specifically, the invention relates to enabling a more accurate resolution of a touch location by increasing the relative signal generated by a touch to the sensor (near field) over a signal generated by any potential background influences(far field) through the use of a thin dielectric film. Examples of such background influences may be signals generated by other parts of the person involved in the touch, such as the hand or another portion of a user's anatomy that is in close proximity to the capacitive touch screen device, such as their arm, head, or the like.

In a capacitive NFI touch screen device, the controller differentiates between the desirable near field effects caused by the touch and undesirable far field effects. The thickness of the protective layer between the touch and the touch sensor circuit directly affects the strength of the signal recognized. As the thickness of the protective layer increases, the strength of the signal created by the touch decreases proportionately. Traditionally, NFI touch screens are designed with sufficient gain in the controller circuitry connected to the touch screen to provide acceptable detection of the near field signal while still adequately rejecting far field effects.

In accordance with the present invention, the ability of the touch sensor to discriminate between near field signals and far field signals is greatly enhanced because as the thickness of the dielectric decreases, the relative distance of the near field implement to the sensor bars is decreased significantly more than the distance of far field objects to the sensor bars. In other words, decreasing the thickness of the dielectric by 50 percent cuts the distance between the touch implement and the touch sensor by roughly 50 percent. However, the distance between any far field contributor and the touch sensor will necessarily have been decreased by less than 50 percent, and most likely by only a few percent. For example, decreasing a dielectric from a thickness of 1 mm to 0.5 mm reduces the distance between a touch and the sensor bars by 50 percent. However, if a far field contributor (e.g., the palm of the touching hand) had been 50 mm from the sensor bars, the distance would only have been reduced by 1 percent to 49.5 mm.

Thus, decreasing the thickness of the dielectric allows the use of a decreased input signal intensity, which reduces far field influences. In addition, increasing the ratio of near field signal over the far field signal makes the near field signal more easily distinguished from the far field signal. Both of these aspects contribute to increased touch detection accuracy. In addition, reducing the input signal intensity results in less power consumption and less electromagnetic interference generated by the touch screen.

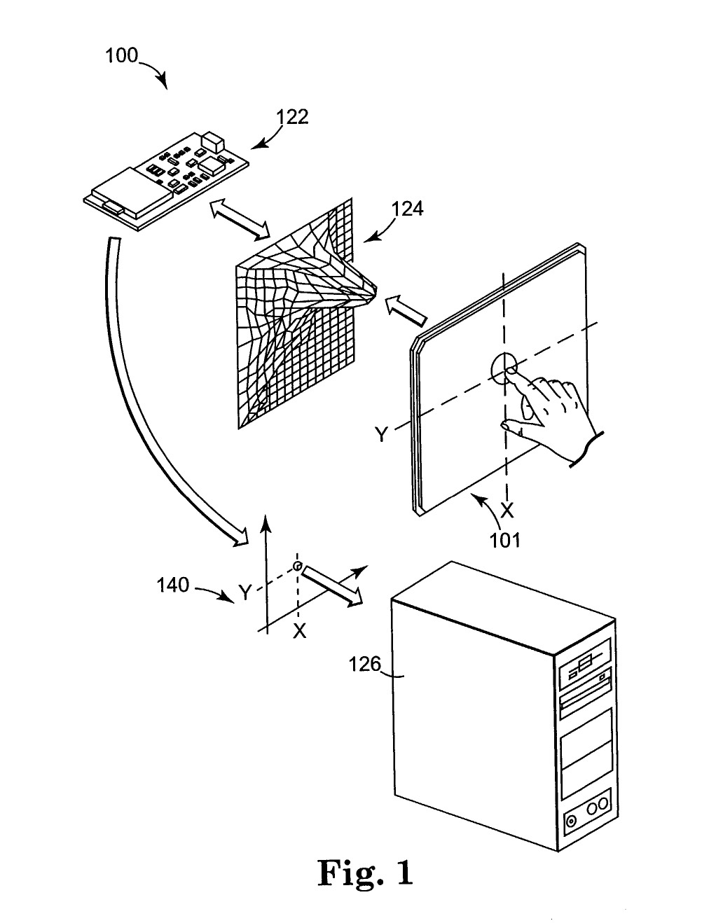

FIG. 1 is a schematic diagram illustrating the general principles of operation of a capacitive touch sensor. In FIG. 1, touch screen system 100 includes touch sensor 101, controller 122, and computer 126. In this particular embodiment, the touch sensor 101 includes a capacitive touch sensing layer overcoated by a thin dielectric film, such as one constructed in accordance with the present invention.

In operation, controller 122 supplies an excitation waveform to the capacitive touch sensing layer of the touch sensor 101, producing an electric field in the capacitive touch sensing layer. When touch sensor 101 is touched, or closely approached, a detectable change or modulation occurs in the electric field due to capacitive coupling between the fingertip and the touch sensing layer. The change or modulation in the electric field creates a signal that is proportional to the proximity and location of the object to the touch sensor 101. The change in the electric field is sensed by the controller 122. The controller 122 resolves the touch through one of several methods to achieve a set of Cartesian coordinates representing the location of the touch. Location graph 140 is a graphical representation of the actual location of the touch on the touch sensor 101. The coordinates of the touch location are provided to another device, for example to computer 126 for execution of a command displayed and touched on the screen. Throughout this specification, claims and drawings, a “touch” is deemed to occur when an object is in proximity to the touch sensor 101 such that a capacitive coupling occurs, thus causing modulation of the electric field. Physical contact need not occur. The object may be any of a number of electrically conductive things, such as a body part (typically a finger), or an inanimate object (typically a stylus). A stylus can be active or inactive, but should be capable of capacitively coupling with the sensor bars through the thin dielectric.

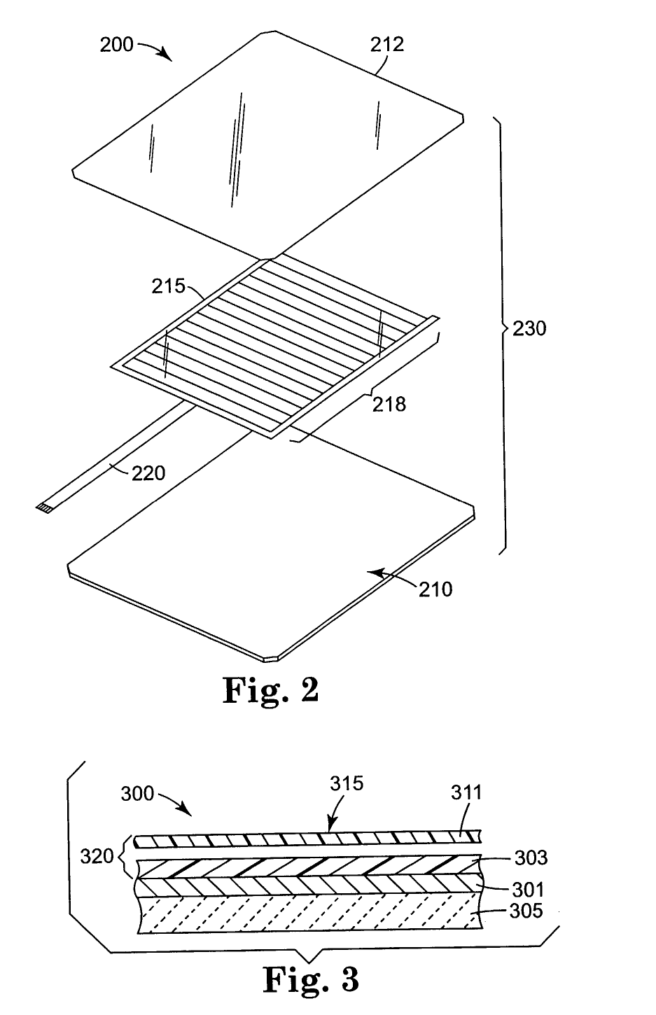

FIG. 2 is an isometric view illustrating a thin face capacitive touch screen according to one embodiment of the present invention. In FIG. 2, thin face touch screen 200 includes a dielectric backing layer 210, a touch sensor circuit 215, and a thin dielectric film 212. Touch sensor circuit 215 includes touch sensor bars 218 and a sensor circuit tail 220. Backing layer 210, touch sensor circuit 215, and thin dielectric film 212 are physically disposed together to form stack-up 230. Stack-up 230 can function as touch screen 101 of FIG. 1, and is suitable for disposition directly on a CRT or LCD screen.

Dielectric backing layer 210 may be a glass sheet, a polyester sheet, or other dielectric sheet or film material. Dielectric backing layer 210 can be an exterior screen surface of an existing cathode ray tube (CRT) monitor, or liquid crystal display (LCD) device, such as a flat screen display for computer or laptop monitor, or a kiosk, arcade game, personal digital assistant (PDA), and similar display devices. In alternative embodiments, stack-up 230 can be disposed directly on a screen suitable for viewing and touching, or with an air-gap between the screen being viewed and stack-up 230.

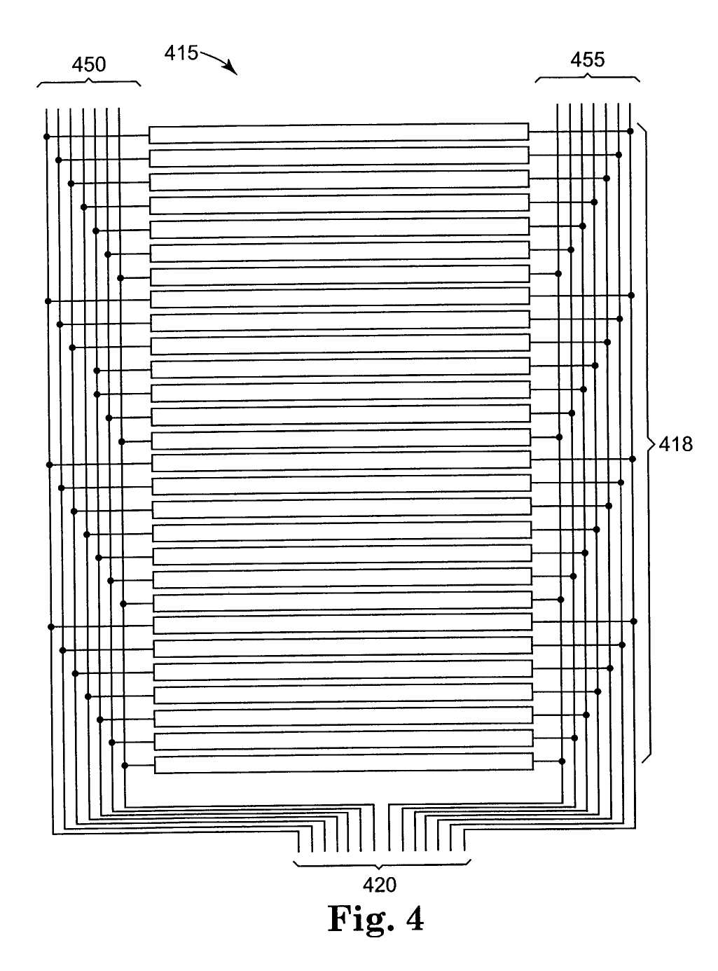

Touch sensor circuit 215 comprises touch sensor bars 218 (which are illustrated schematically) and the corresponding lead lines for the touch sensor bars (not shown) which are bundled or formed together as sensor circuit tail 220. Additional detail related to touch sensor circuit 215 and touch sensor bars 218 is contained in the disclosure related to FIG. 4. Touch sensor circuit 215 is disposed upon backing layer 210 by any suitable means, including direct application as illustrated above, or by any suitable laminating or bonding process.

The thin dielectric film 212 may be any dielectric material approximately 0.030 inches thick or less that is suitable for protecting touch sensor circuit 215 from an external environment. Dielectric sheets and films of less than approximately 0.030 inch thick can be employed to produce an acceptable protective thin dielectric film between the user and the sensor bars. The thin dielectric film may be of either single layer or multi-layer construction. In single layer applications, a single material may be used to cover a sensor bar circuit and provide the touch surface. Alternatively, a first coating of protective material may be overcoated with another material, such as an antireflective material, a scratch or smudge resistant material, an anti-microbial coating, or any combination of those. The thin dielectric film and other components of the invention can be transparent or opaque, depending on the intended application of the invention.

Sprayable dielectric compounds can be employed to produce a protective thin dielectric film, with resulting thicknesses less than approximately 0.005 inches. Silicon dioxide and other suitable dielectrics suitable for sputter coating, sol-gel process, or other means of depositing Angstrom level thin dielectric films can be employed, with resulting thicknesses in a range as thin as 1,000 to 10,000 Angstroms. The thin dielectric film may be either comprised of or include birefringent or non-birefringent material, tinted, anti-reflective, and anti-glare materials. Alternative embodiments of thin dielectric film 212 include: polyester films, which typically are available in 0.003, 0.005, and 0.007 inch thick films; polycarbonate and acrylic sheets, which typically are available in 0.010, 0.020, 0.030, and 0.030 inch thick sheets; silicon dioxide, which can be sputter coated or applied employing sol-gel techniques with a wide variety of resulting thickness, including thicknesses in the range of 1,000 to 10,000 Angstroms; and dielectric compounds capable of being sprayed or dipped to form a thin protective film on the touch sensor bars and other portions of the touch sensor circuit, such as urethanes which can be applied in thicknesses of approximately 0.0005 inch films. The desired thickness of film 212 may vary, depending upon the environment in which the touch screen will be used, and the nature of the touch (rough or gentle). In an alternative embodiment, film 212 is less than 0.010 inches thick. In alternative embodiments where thin dielectric film 212 is made from sheet or roll stock, the stock is disposed on the stack-up of touch sensor circuit 215 and backing layer 210 by overlaying the material, with or without adhesive or bonding. For example, polyester films can be laminated onto the stack-up of touch sensor circuit 215 and backing layer 210. Polycarbonate sheet can be laminated onto the stack-up of touch sensor circuit 215 and backing layer 210.

In an alternative embodiment, thin dielectric film 212 may be a polarizing material for use, for example, in glare reduction or as the top polarizer when the touch sensor 200 is integrated with an LCD screen. In another alternative embodiment, thin dielectric film 212 may itself form or be provided with an anti-reflection coating, anti-glare coating, tint for optimum viewing under certain lighting conditions, privacy filter, or any other desired agent, so long as it is a dielectric, non-conducting, insulating material. Such additional coatings or layers may be disposed on either surface of thin dielectric film 212. The invention is not limited by the type of film 212 employed or the method of disposition to touch sensor circuit 215 and backing layer 210. In an alternative embodiment, film 212 can comprise any surface that accepts a transfer of text and/or images. The method of transfer can include printing, affixing a decal, and screening.

Thin dielectric film 212 may be formed by direct application of the dielectric material to the stack-up of touch sensor circuit 215 and backing layer 210. Direct application methods can include spraying, coating by application of a suspension or solution that is a carrier for the film forming agent (e.g., in situ formation of the film), printing, dip coating, gravure coating, draw bar coating, sol-gel techniques, diamond coating, sputter coating, and any other method suitable for the materials employed.

FIG. 3 is a cross sectional view of an illustrative touch sensor 300 having a sensor circuit 301 disposed between a backing layer 305 and a thin dielectric film 303. Each of these three layers may be constructed in accordance with their respective descriptions provided above. The touch sensor 300 of FIG. 3 further includes a removable protective element 311 disposed adjacent to the thin dielectric film 303 in such a manner as to protect the thin dielectric film 303 from abrasion by touch implements or other environmental factors, in accordance with the present invention. It is not necessary to distance the protective element 311 from the thin dielectric film 303 by an air gap as illustrated in FIG. 3. The protective element 311 may be attached directly to the dielectric film 303. An adhesive may or may not be used to attach the protective element 311 to the thin dielectric film 303.

As discussed above, the sensor circuit 301 is of sufficient sensitivity that a touch to a touch surface 315 on the protective layer 311 may be sensed by the sensor circuit 301 at a distance 320 from the sensor circuit 301 through the thin dielectric film 303 and the protective layer 311. Moreover, the protective layer 311 is removably attached to the touch sensor 300 such that the protective layer 311 may be replaced from time to time, such as when the protective layer 311 becomes severely scratched or damaged from use, wear, vandalism, or the like. In one implementation, the protective layer 311 may include multiple layers of protective material with each layer being separately removable. In that way, each of the multiple layers may be removed when the touch surface becomes scratched or otherwise damaged. Then, when the final layer is removed, the multiple-layer protective layer 311 may be replaced. One example of a tear-off protective film that may be used in such a multiple-layer protective layer 311 is disclosed in International Publication WO 00/24576. The touch sensor 300 thus configured may have particular applicability in harsh environments where touch screens may be used and subjected to more abuse than is tolerable by conventional touch screens. Examples of such environments may be open air kiosks, a production or manufacturing environment, and the like.

FIG. 4 is a schematic representation of an exemplary capacitive touch sensor 415. In FIG. 4, touch sensor 415 comprises a plurality of sensor bars 418, a set of lead lines 450, another set of lead lines 455, and sensor circuit tail 420.

The plurality of sensor bars 418 typically spans the area intended to be used for a touch screen. In an alternative embodiment, the individual sensor bars of the plurality of sensor bars 418 are arranged substantially parallel to each other. The individual sensor bars of the plurality of sensor bars 418 preferably have resistance characteristics that vary linearly over the length of the bars, and respond to a touch by allowing an alteration of the electric field created by the excitation waveform applied to the sensor bars. Touch sensor 415 may employ any appropriate architecture for connecting sensor bars 418 to a set of lead lines 450 and another set of lead lines 455 (the lead line architecture depicted in FIG. 4 is for illustrative purposes only and not intended to depict a functional embodiment of lead line architecture).

Sensor bars 418 may be any conductive material possessing appropriate physical properties and non-reactive with other components of a touch screen. They are preferably constructed of indium tin oxide (ITO) for optically transparent applications, but may be constructed of any suitable conductive material. The number of bars employed in any application can vary depending upon the design parameters of the particular application. Sensor bars 418 can be formed by applying ITO to a dielectric backing layer (such as dielectric backing layer 210 of FIG. 2), applying a mask layer, and etching away the unwanted areas of ITO. In an alternative embodiment, sensor bars 418 can be formed separately on a separate substrate (not shown), and then disposed upon a dielectric backing layer. In still another alternative, the sensor bars 418 may be patterned onto a flexible layer that will ultimately be the thin dielectric layer. In that way the sensor circuitry may then be bonded to a support substrate using an adhesive, such as an optical adhesive.

In an alternative embodiment, the individual sensor bars of sensor bars 418 can be various configurations and shapes other than a rectangle with conducting material deposited uniformly inside of a perimeter. For example, the individual sensor bars could comprise a conducting perimeter and a non-conducting area within the perimeter. By way of further example, the sensor bars could comprise a loop or other configuration whose perimeter does not close. The sensor bars can be any shape capable of creating an input signal in response to a touch, the signal being representative of the touch location.

Both asymmetrical and symmetrical arrangements of lead lines may be used with sensor bars 418. The ends of the lead lines 450 and 455 are gathered into a sensor circuit tail 420 for connection to an electronic control circuit (not shown). The lead lines supply a signal from the electronic control circuit to the sensor bars 418. In general, the lead lines may be made of practically any conductive material, such as copper, silver, gold, or similar conductive materials.

In an alternative embodiment, each sensor bar is only connected to a lead line at one end. Thus, plurality of sensor bars 418 can be only coupled to set of lead lines 450. Lead lines 455 are not employed in this alternative embodiment.

Two examples of thin film touch screens were built embodying the invention. In the first example, a thin film touch screen was constructed by coating a 17-inch capacitive touch sensor with an approximately 0.001-inch polyester film, and disposed onto a CRT monitor. The thin film touch screen was operated with a controller configured for use with a thin film touch screen, the configuration including a reduction in the amount of gain employed to resolve a touch location. The 17-inch screen was given both drag and discrete touch tests. This screen can be safely integrated in a metallic or insulating bezel. It can also be mounted behind an existing window for use outside, such as a kiosk window.

In the second example, a 10.4-inch thin film touch screen was constructed by manually spraying a thin dielectric hard coat onto a touch sensor. It was disposed on a LCD monitor and successfully tested in the same manner as the first example.

Both examples demonstrated the advantages and effectiveness of a thin film touch screen. Because of the increased signal strength, both examples allowed the controller to resolve a touch location with a higher degree of accuracy than typically encountered with exterior film thicknesses greater than 0.030 inches. Due to their high degree of accuracy, the thin film touch screens have great potential for use with computer monitors and laptop LCD screens to handle fine graphics.

By way of further advantage, the thin face capacitive touch screen can be disposed upon the viewing surface of the visual device without any air gaps that would otherwise reduce light transmissibility.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A thin face capacitive touch screen for use in determining the location of a touch to a touch surface of a device by a touch implement, comprising:
a dielectric backing layer;
a capacitive touch sensor circuit comprising a plurality of sensor bars, the capacitive touch sensor circuit being affixed to the dielectric backing layer; and
a thin dielectric film having a first surface and a second surface, the first surface being affixed to the capacitive touch sensor circuit and the second surface being oriented as the touch surface.

2. The thin face capacitive touch screen of claim 1, wherein the sensor bars are arranged substantially parallel.

3. The thin face capacitive touch screen of claim 1, wherein the thin dielectric film is less than approximately 0.030 inches thick.

4. A thin face capacitive touch screen for use in determining the location of a touch to a touch surface of a device, comprising:
a dielectric backing layer;
a capacitive touch sensor circuit comprising a plurality of sensor bars, and disposed on the dielectric backing layer; and
a thin dielectric film providing the touch surface, wherein the thin dielectric film is less than approximately 0.030 inches thick and is disposed on the sensor circuit layer opposite the dielectric backing layer.

5. The thin face capacitive touch screen of claim 4, wherein the sensor bars are arranged substantially parallel.

6. The thin face capacitive touch screen of claim 4, wherein the thin dielectric film is less than approximately 0.020 inches thick.

7. The thin face capacitive touch screen of claim 4, wherein the thin dielectric film is less than approximately 0.010 inches thick.

8. The thin face capacitive touch screen of claim 4, wherein the thin dielectric film is less than approximately 0.005 inches thick.

9. The thin face capacitive touch screen of claim 4, wherein the thin dielectric film comprises a polycarbonate material.

10. The thin face capacitive touch screen of claim 4, wherein the thin dielectric film comprises an acrylic material.

11. The thin face capacitive touch screen of claim 4, wherein the thin dielectric film comprises a polyester film.

12. The thin face capacitive touch screen of claim 4, wherein the thin dielectric film comprises a dielectric compound adapted for disposition on the sensor circuit by spraying.

13. The thin face capacitive touch screen of claim 4, wherein the thin dielectric film is disposed on the sensor circuit by a selected one of direct application, bonding, lamination, spraying, sputtering, and sol-gel method.

14. The thin face capacitive touch screen of claim 4, wherein a surface of the thin dielectric film accepts transfer of at least a selected one of text and image.

15. The thin face capacitive touch screen of claim 4, wherein the screen is substantially transparent.

16. The thin face capacitive touch screen of claim 4, wherein the screen is substantially opaque.

17. The thin face capacitive touch screen of claim 4, wherein the thin dielectric film further comprises a birefringent material.

18. The thin face capacitive touch screen of claim 4, wherein the thin dielectric film further comprises a selected one of anti-reflective coating, anti-glare coating, and tinting.

19. The thin face capacitive touch screen of claim 4, wherein the dielectric backing layer comprises a portion of the viewing surface.

20. The thin face capacitive touch screen of claim 4, wherein the dielectric layer comprises silicon dioxide.

21. A capacitive touch screen for use in determining the location of a touch to a surface of a device, comprising:
a dielectric backing layer;
a capacitive touch sensor circuit comprising a conductive touch sensing means, the conductive touch sensing means being capable of creating an input signal in response to the touch that is representative of the touch location, and the capacitive touch sensor circuit being disposed on the dielectric backing layer; and
a thin dielectric film, wherein the thin dielectric film is less than approximately 0.030 inches thick, and is disposed on the sensor circuit layer opposite the dielectric backing layer.

22. The capacitive touch screen of claim 21, further comprising:
a protective layer disposed adjacent to the thin dielectric film on a side opposite the capacitive touch sensor circuit, the protective layer being removably affixed to the capacitive touch screen such that the protective layer may be replaced from time to time.

23. A method for providing a thin face capacitive touch screen for use in determining the location of a touch to a viewing surface of a visual device, comprising:
providing a capacitive touch sensor circuit comprising a plurality of sensor bars;
providing a dielectric backing layer;
disposing the capacitive touch sensor circuit on one surface of the dielectric backing layer;
providing a thin dielectric film; and
disposing the thin dielectric film on the sensor circuit opposite the surface with the backing layer.

24. The method of claim 23, wherein the dielectric backing layer comprises at least a portion of the viewing surface.

25. A system for providing a signal for use in determining the location of a touch to a touch surface of a device, comprising:
the device comprising:
(a) a capacitive touch sensor circuit, the circuit comprising a plurality of sensor bars;
(b) a dielectric backing layer on which the capacitive touch sensor circuit is disposed; and
(c) a thin dielectric film disposed on the sensor circuit on a surface opposite the backing layer, one surface of the thin dielectric film being the touch surface, and the thin dielectric film being less than approximately 0.030 inches thick; and
the capacitive touch sensor circuit being operative to perform the following tasks:
(a) receive an electrical field for application to the bars of the sensor circuit;
(b) receive the touch;
(c) generate a signal representative of a modulation of the electrical field caused by the touch to at least one sensor bar, the signal being suitable for use in determining the location of the touch; and
(d) return the signal.

26. The system of claim 25, wherein the sensor bars are arranged substantially parallel.

27. The system of claim 25, wherein the dielectric backing layer comprises at least a portion of the viewing surface.

28. A display device, comprising:
a visual display device for presenting a visual image; and
a touch screen including a touch sensor and an electronic controller, the touch screen being affixed adjacent to the visual display device, the electronic controller being operative to detect a touch to the touch sensor, the touch sensor including a sensor circuit and a thin dielectric film, the thin dielectric film being affixed to the sensor circuit on a side opposite of the visual display device.

29. The display device of claim 28, wherein the visual display device is configured as a dielectric backing layer upon which the sensor circuit is affixed.

30. The display device of claim 29, wherein the visual display device comprises a Liquid Crystal Display device.

31. The display device of claim 30, wherein the touch screen further comprises an outer polarizer layer that operates in conjunction with the Liquid Crystal Display device to present the visual image.

32. The display device of claim 28, wherein the visual display device comprises a Cathode Ray Tube device.

33. The display device of claim 28, wherein the display device further comprises a removable protective layer affixed adjacent to the touch screen.

34. The display device of claim 28, wherein the thin dielectric film comprises a flexible film sufficient to allow the touch screen to conform to the shape of the visual display device.
